(19) United States
(12) Patent Application Publication
(10) Pub. No.: US 2004/0130164 A1
(43) Pub. Date: Jul. 8, 2004

(54) Wire gate latch

(76) Inventor: James Ray Burch, Anderson, MO (US)

Correspondence Address: James R. Burch, Rt 1 Box 287, Anderson, MO, 64831, US

(21) Appl. No.: 10/336,526

(22) Filed: Jan. 6, 2003

(51) Int. Cl. E05C 19/10

(52) U.S. Cl. 292/246

(57) ABSTRACT

The gate latch described is for maintaining a wire gate in a closed position between a pair of gateposts embedded in the ground. The gate latch comprises a 36″ piece of #2 chain that is wrapped around the gatepost and secured by ¼″×1″ bolt and lock nut. The gate tension is adjusted by lengthening or shortening the chain. The gatepost is placed in the u-shape portion of the steel rod and pivots around the post when the handle is pushed toward the top wire of the gate. When the handle is in position, the hook on the end of the handle is hooked over the top wire of the gate, and the gate is in the closed position.

### BACKGROUND OF THE INVENTION

This invention relates to a latch, and more particularly, to a gate latch for closing a post and wire gate.

Conventional wire gates are normally used to close the space between a pair of gateposts, which are embedded in the ground. The wire gates are normally comprised of a plurality of wires, usually barbed wire, which are secured at one end to one of the gates posts and which have a post member secured to the other end thereof.

When it is desired to close the gate, the lower end of the post member is normally positioned in a wire loop secured to the other gatepost. The upper end of the post member is then forced into position adjacent the gatepost so that another loop may be passed over the upper end of the post member and the gatepost. The opening and closing of such gate is extremely difficult since the movement of the post member towards the gatepost is resisted by the tension in the gate wires. The opening and closing of the gate is further complicated by the fact that the wires on the gate are normally of the barbed type, and the person opening or closing the gate frequently tears his clothing or cuts himself.

It is therefore a principal object of this invention to provide an improved gate latch for a wire gate.

A further object of the invention is to provide an improved gate latch, which facilitates the opening and closing of long wire gates.

A further object of the invention is to provide a gate latch that prevents injury to the person opening or closing the gate.

A further object of the invention is to provide a gate latch that prevents the person opening or closing the gate from tearing his clothing.

A further object of the invention is to provide a gate latch that positively maintains the gate in a closed position.

Still another object of the invention is to provide a gate latch that keeps enough tension on the wire gate to prevent livestock from rubbing against the gate and tearing it down.

These and other objects will be apparent to those who have opened and closed a wire gate.

### SUMMARY OF THE INVENTION

The gate latch described is adapted for use in closing a wire gate that extends between a pair of gateposts embedded in the ground.

The gate latch of this invention is comprised of a 24″×7/16″ rod, a 36″×#2 straight link chain welded to the rod, a ¼″×1″ bolt with a ¼″ lock nut, and a ½ link of #2 chain welded to the rod.

The U-shape at the end of the rod is designed to pivot around the post, under the top wire, and the ½ link of #2 chain at the end of the rod is hooked over the top wire in a secured position. The lower end of the post member is inserted into a u-shaped loop member that is secured to the lower end of the gatepost. The gate tension can be adjusted by lengthening or shortening the chain.

### BRIEF DESCRIPTION OF THE DRAWINGS

FIG. 1 is a view illustrating the gate latch of this invention being used to maintain a wire gate in a closed position.

FIG. 2 is a partial view similar to FIG. 1 illustrating the initial position of the relative components.

FIG. 3 is a view similar to FIG. 2 illustrating the gate latch being used to close the gate.

FIG. 4 is a perspective view of the gate latch of this invention.

### DETAILED DESCRIPTION OF THE INVENTION

Referring to the drawings, the numeral 10 refers to a conventional wire gate that is adapted to be extended between a pair of gateposts (12 and 14) that are embedded in the ground (16). Conventional wires, usually of the barbed type, extend from the gateposts (12 and 14) in a conventional fashion.

The gate (10) is compromised of a plurality of wire members (18) that are secured to the gatepost (12) and extend there from. An end post member (22) is secured to the “free” ends of the wire members (18) as illustrated in the drawings.

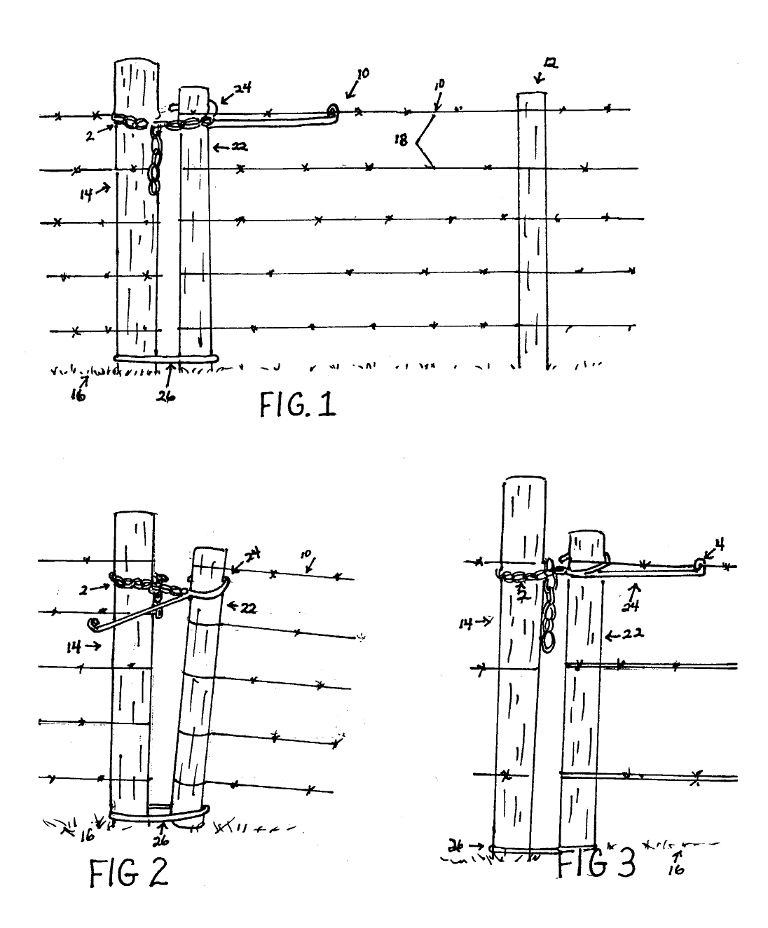

The gate latch of this invention is referred to generally by the reference numeral 24. It is designed to pull the post member (22) towards the gatepost (14) and to maintain the post member (22) in the position illustrated in FIG. 1 so that the space between the gateposts (12 and 14) will be closed by the gate (10).

The numeral 26 refers to a lower connection means. It is secured to the lower end of the gatepost (14), and is substantially u-shaped, so that it may receive the lower end of the post member (22) as illustrated in the drawings. Although the drawings illustrate the connection means (26) to be of the “strap” type, the connection means (26) could be formed by wrapping wire around the lower end of the gatepost (14). A substantially u-shaped member is provided which can receive the lower end of the post member.

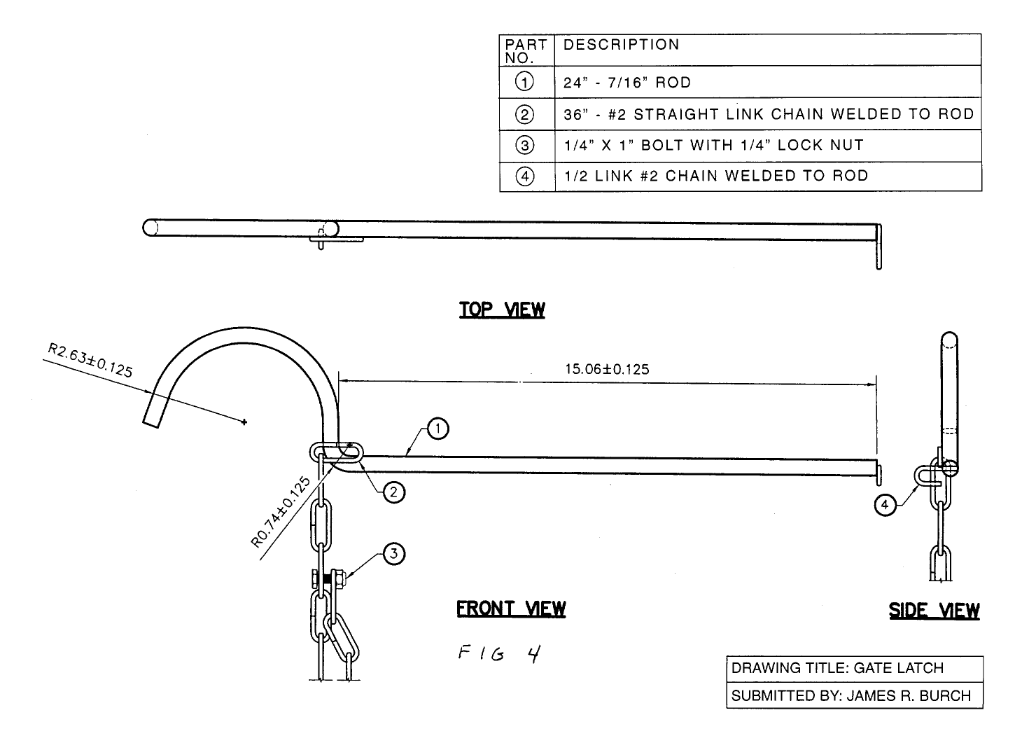

When it is desired to close the gate (10), the lower end of the post member (22) is inserted into the connector (26) as illustrated in FIG. 2. The u-shape at the end of the rod is hooked around the post (22), under the top wire. The lower end of the rod (1) is pushed and the u-shape is pivoted around the post (22). The ½ link of #2 chain (4) is hooked over the top wire, securing the latch (FIG. 3).

When it is desired to open the gate, unhook the ½ link of #2 chain (4—FIG. 3) and let the lever portion of the latch (1) swing toward the gatepost (14—FIG. 2).

This gate latch described clearly enables a wire gate to be easily opened and closed in a manner that all of the stated objectives are achieved.

I Claim: In combination,

1. First and second vertically disposed and horizontally spaced-apart Gateposts

2. A plurality of substantially horizontally disposed and vertically spaced elongated wire members secured at one end to said first gatepost and extending there from towards said second gatepost

3. A post member secured to the other end of said wire members and adapted to be positioned adjacent to said second gatepost

4. A first connection means secured to said second gatepost adjacent to the lower end thereof, adapted to receive the lower end of said post member

5. Said first connection means comprising a substantially u-shaped rigid strap member having parallel legs, the end of each leg being secured to said second gatepost and forming a u-shaped loop to receive said post member

6. A second connection means secured to the top end of said second gatepost for connection to the upper end of said post member

7. Said second connection means comprising:
a. 24″×7/16″ rod with a u-shape on the end of the rod designed to pivot around the gatepost
b. 36″×#2 straight link chain welded to the rod with a ¼×1″ bolt with a ¼″ lock nut designed to be shortened or lengthened around the gatepost to adjust the wire tension
c. ½ link #2 chain welded to the rod to hook over the top wire of the gate to secure the latch
